(19) United States
(12) Patent Application Publication
(10) Pub. No.: US 2021/0300745 A1
(43) Pub. Date: Sep. 30, 2021

(54) Cork Removal Device

(71) Applicant: Trent Walker, West Orange, NJ (US)

(72) Inventor: Trent Walker, West Orange, NJ (US)

(21) Appl. No.: 16/834,714

(22) Filed: Mar. 30, 2020

(51) Int. Cl. B67B 7/04; B67B 7/06

(52) U.S. Cl. CPC B67B 7/0411; B67B 7/063

(57) ABSTRACT

An improved cork removal device that reduces the pressure differential created when a cork is extracted. The device provides for the passage of air from outside of the bottle through the cork, through a passageway in an elongated rod extending from the handle. The elongated rod has openings at a distal end and near the handle, connected with a passageway. This means that when the elongated rod of the cork removal device is inserted into a cork which is sealing a wine bottle, air is free to pass from one opening through the passageway to the other opening. The passage of air when the cork is being extracted, prevents a pressure differential from preventing the cork from extraction, and reduces breakage of the cork. A small flange or expansion at the tip of the corkscrew may be provided to protect the distal end opening from being clogged by cork debris.

### FIELD OF INVENTION

This invention generally relates to the removal of corks from bottles, in particular, but not limited to, wine bottles.

### BACKGROUND

Corks have been used to seal bottles and other containers for centuries. There are a number of ways to extract corks from corked enclosures which we shall generally refer to as wine bottles for simplicity. Many of these cork removal devices use corkscrews, others use a two-pronged type of opener known as an ah-so. The corkscrew devices generally utilize a solid spiral or coil rotationally inserted into a cork, and then the corkscrew is pulled away from bottle, pulling the cork along with the corkscrew. The ah-so device has at least two substantially flat prongs that are inserted between the exterior side of the cork and the interior side of the wine bottle, where by pulling outward and twisting, the cork is removed from the bottle.

Using these type of devices requires some manual strength as well as the possibility of cork breakage. Part of the reason it requires some strength is that there is usually a non-liquid volume of air or gas, or perhaps a vacuum, inside the bottle between the cork and the surface of the liquid contained within the bottle. As the cork is removed, the fixed amount of air in the now-expanding space creates a vacuum-like pressure differential. For a ¾ inch diameter cork this gives a surface area of the top of the cork of approximately 0.44 inches squared. At sea level, this means air pressure on the cork is 6.6 pounds, assuming the cork is drawn against a vacuum. Since corks are known to be excellent at being airtight, this results in a significant amount of effort to withdraw the cork (over and above the friction of the cork against the walls of the bottle). Moreover, given partial air leakage down the cork or fragility in the cork, different parts of the cork can be subjected to this intense air pressure, resulting in cork breakage.

Cork breakages occur frequently in older bottles where the cork has become fragile over time. Many corks are made of natural products, the traditional cork being a piece of tree bark. As corks age changes in the organic composition of this cork occur, and for old enough bottles “recorking” is recommended. These extremely fragile corks can easily crumble even with gentle pressure, resulting in cork fragments in the wine or contained liquid.

Attempts to address the pressure differential include cork removal devices that inject air through the cork and into the bottle, but such devices increase the complexity of the cork removal device.

It is therefore the objective of the present invention to remove or reduce this pressure differential when removing a cork from a bottle, by modifying the basic corkscrew and the ah-so.

### SUMMARY

The invention is a new form of cork removal device that allows for fewer broken corks and easier opening of wine bottles by reducing the pressure differential created when a cork is extracted. The device provides a channel for the passage of air from outside of the bottle to inside of the bottle. A traditional corkscrew is modified to provide a passageway within the corkscrew. The corkscrew has an opening at the operational or entry end of the corkscrew and an opening at the top of the corkscrew near the handle, with a passageway connecting the two openings, allowing for air to travel between the openings via the passageway. This allows air to pass freely between the openings, reducing the pressure within the bottle.

The ah-so opener is modified to provide a channel along the length of at least one of the prongs, creating a passageway that allows air to travel along the length of the prong and around the cork to equalize the pressure within the bottle. The channel may be formed as a hollow passageway within at least one of the prongs, or may be formed as an external channel in at least one of the prongs.

The advantage of the present invention is reducing the vacuum effect when the cork is being extracted. This vacuum can make the cork difficult to extract and cause breakage of the cork.

The invention is relevant to all forms of vertical lift openers for corked bottles and is not limited to the traditional twist and pull corkscrew. This pressure normalization is relevant to all forms of corkscrews including, but not limited to, twist corkscrews, waiter's corkscrews, winged corkscrews, electric wine openers, lever corkscrews, rabbit corkscrews, and the Durand corkscrew.

In order to minimize clogging the opening in the corkscrew, a flange or ridge may be provided near the openings, shielding inlet behind this flange or ridge, and preventing cork from entering the opening and reducing the desired airflow.

### BRIEF DESCRIPTION OF THE DRAWINGS

FIG. 1 is a perspective view of a corkscrew spiral, showing openings.

FIG. 2 is a side view of a corkscrew opener inserted into a wine bottle.

FIG. 3 is a front view of an ah-so opener inserted into a wine bottle.

FIG. 4 is a side view of an ah-so opener showing another embodiment with an external channel.

FIG. 5 is a cross-section view along line B-B in FIG. 4.

FIG. 6 is a perspective view of a corkscrew spiral, showing another embodiment with a protective flange.

FIG. 7 is a close up view of the tip of the corkscrew spiral of FIG. 6.

FIG. 8 is a cross-section view along line A-A in FIG. 1.

### DETAILED DESCRIPTION

The invention preferably consists of an elongated rod 13 with a handle 19, where elongated rod 10 provides a channel 15 capable of allowing air to pass therethrough. Elongated rod 10 is capable of penetrating a cork 40 that has been inserted into a bottle 50. By penetrating, it is understood that elongated rod may enter a periphery of cork 40, adjacent to bottle 50.

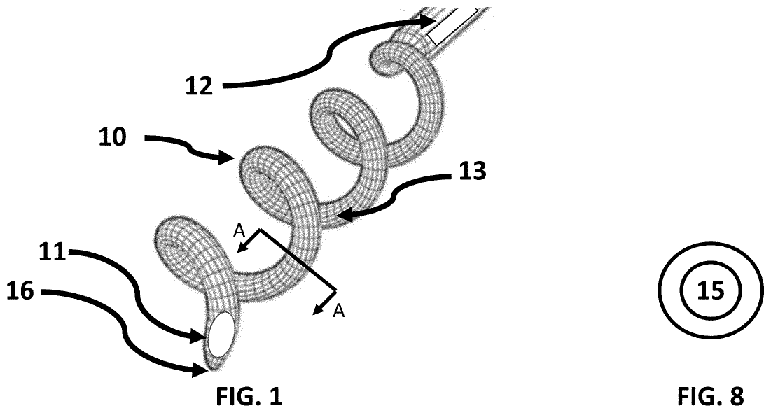

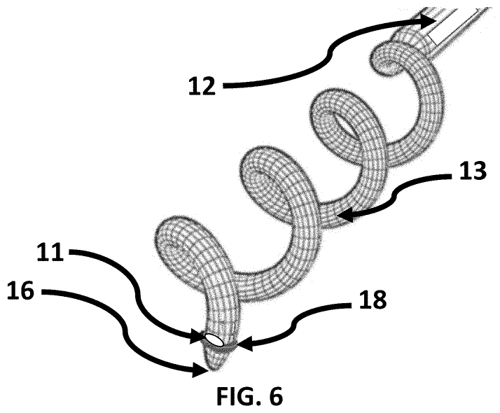

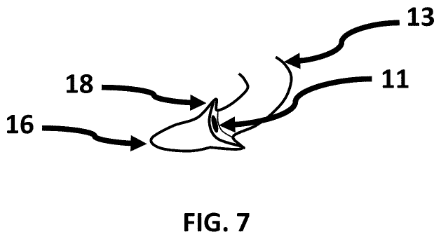

In a preferred embodiment, elongated rod 10 is configured in a spiral 13 as shown in FIGS. 1, 2 and 6. Elongated rod 10 is attached to handle 19 at one end, and the spiral 13 extends away from handle 19 as is known in the art for corkscrews. Spiral 13 tapers off to distal end 16 of elongated rod 13. Distal end 16 is preferably formed to a point for penetration of the cork 40. The overall shape of this embodiment appears similar to a conventional corkscrew.

First opening 11 is formed near the distal end 16 of elongated rod 10. Second opening 12 is formed on elongated rod 10 near handle 19. Channel 15 extends through spiral 13 and elongated rod 10, connecting first opening 11 and second opening 12 and allowing for the passage of air therethrough.

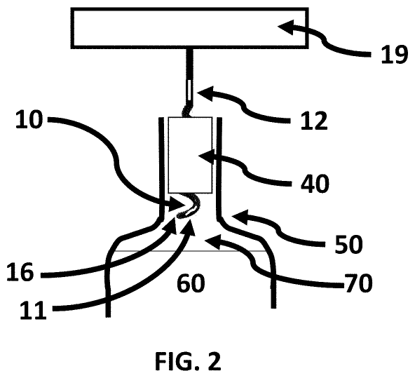

In use, distal end 16 of elongated rod 10 is inserted into cork 40, and handle 19 is rotated to drive spiral 13 of elongated rod 10 into and through cork 40, as is known in the art. As shown in FIG. 2, after spiral 13 has been rotated in a usual manner, distal end 16 emerges into space 70 formed between cork 40 and liquid 60 within bottle 50. As first opening 11 is located near distal end 16, air may now flow freely through first opening 11 and channel 15, equalizing the air pressure between space 70 and the outside of bottle 50.

To remove cork 40, a user may then pull handle 19 in a direction away from bottle 50, pulling cork 40 away from liquid 60. The movement of cork 40 creates a temporary pressure differential in space 70, causing air to flow into second opening 12, through channel 15 and out of first opening 11 to balance the air pressure in space 70 to match the air pressure outside of bottle 50.

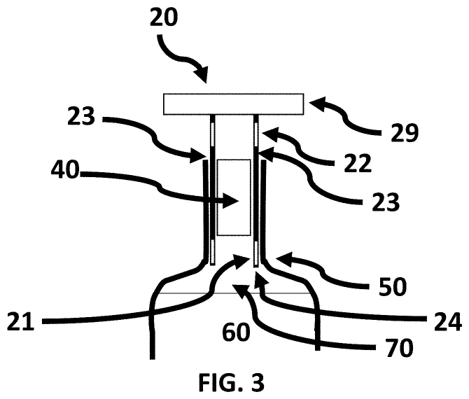

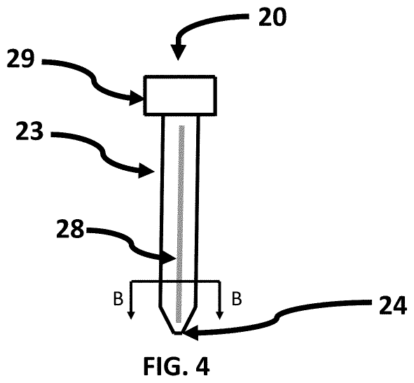

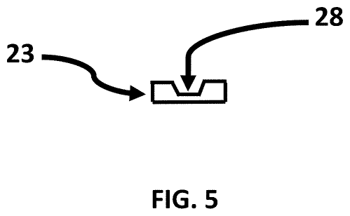

To avoid cork particles from entering first opening 11 when spiral 13 is rotated to enter cork 40, expansion flange 10 may be located near distal end of elongated rod 10 to deflect cork particles from entering first opening 11 as elongated rod 10 is inserted into cork 40. In an alternate embodiment, a fine mesh may be placed in first opening 11 to reduce or prevent the entry of cork particles.

Where an ah-so style of cork removal device is used, there are at least two elongated rods 23 attached to handle 20, as shown in FIG. 3, where each elongated rod 23 has a distal end located away from handle 20. The elongated rods 23 of the ah-so embodiment are generally planar in configuration as is known in the art, presenting a thin profile to allow insertion between the cork and bottle.

At least one elongated rod 23 has first opening 21 located near the distal end 26 and a second opening 22 located near the handle 20. As with the corkscrew embodiment, a channel 15 extends through elongated rod 23 from first opening 21 to second opening 22, allowing the passage of air therethrough. As shown in FIG. 3, one embodiment will provide both of the at least two elongated rods 23 with first opening 21, second opening 23 and channel 15 extending therethrough.

In an alternate embodiment of the ah-so style of cork removal device, elongated rod 23 has a channel 28 extending along a substantial portion of the length of elongated rod 23. Channel 28 extends along the planar surface of elongated rod 23, and may be oriented toward cork 40 and away from bottle 50, or oriented away from cork 40 and toward bottle 50. When elongated rod 23 with channel 28 is inserted adjacent to cork 40, channel 28 provides for the passage of air therethrough from space 70 to outside of bottle 50.

The ah-so embodiment can be modified to use additional channels or ridges on the elongated rod 28 of the ah-so allowing for the passage of air and equalization of pressure.

While certain novel features of the present invention have been shown and described, it will be understood that various omissions, substitutions and changes in the forms and details of the device illustrated and in its operation can be made by those skilled in the art without departing from the spirit of the invention.

I claim:

1. A cork removal device comprising:
a handle; and
an elongated rod, with an attachment end and a distal end, the attachment end attached to the handle, the distal end extending away from the handle, the elongated rod capable of extracting a cork from a bottle, where the elongated rod comprises a passageway allowing for air to travel therethrough.

2. The cork removal device of claim 1, where the elongated rod comprises:
a first opening proximate to the distal end;
a second opening proximate to the attachment end; and
where the passageway extends from the first opening to the second opening.

3. The cork removal device of claim 1, where the elongated rod further comprises a spiral.

4. The cork removal device of claim 3, where the passageway extends through the spiral.

5. The cork removal device of claim 3, further comprising:
a flange located near the distal end of the elongated rod, extending laterally in a direction away from the spiral.

6. The cork removal device of claim 1,
where the elongated rod further comprises an inward planar surface and an outward planar surface, the inward planar surface and outward planar surface extending from the attachment end to the distal end;
where the cork removal device further comprises a second elongated planar rod, the second elongated planar rod comprising a second attachment end, a second distal end, and a second inward planar surface and a second outward planar extending from the second attachment end to the second distal end; and
where the planar surface of the elongated rod and the second planar surface of the second elongated planar rod are roughly parallel to each other.

7. The cork removal device of claim 6, where the elongated rod further comprises an elongated channel extending along the inward planar surface from the distal end toward the attachment end.

8. The cork removal device of claim 6, where the elongated rod further comprises an elongated channel extending along the outward planar surface from the distal end toward the attachment end.
